(19) United States
(12) Patent Application Publication
(10) Pub. No.: US 2019/0173644 A1
(43) Pub. Date: Jun. 6, 2019

(54) REFERENCE SIGNAL MEASUREMENT METHOD AND APPARATUS

(71) Applicant: Huawei Technologies Co., Ltd., Shenzhen (CN)

(72) Inventors: Yongxia Lyu, Ottawa (CA); Zhiheng Guo, Beijing (CN); Wei Sun, Shenzhen (CN)

(21) Appl. No.: 16/271,561

(22) Filed: Feb. 8, 2019

Related U.S. Application Data
(63) Continuation of application No. PCT/CN2017/093476, filed on Jul. 19, 2017.

(30) Foreign Application Priority Data
Aug. 10, 2016 (CN) 201610652011.7

(51) Int. Cl. H04L 5/00; H04W 24/08; H04W 72/04

(52) U.S. Cl. CPC H04L 5/0048; H04W 88/02; H04W 72/0453; H04W 24/08

(57) ABSTRACT

In a channel state information receiving method, a base station sends first signaling to a terminal device. The first signaling includes sounding reference signal (SRS) information of each of a plurality of subbands. The SRS information of each subband comprises at least one of: a period of an SRS in the subband, a starting position of the SRS in the subband, an offset position of the SRS in the subband, and a port number of the SRS in the subband. The base station receives an SRS in at least one of the plurality of subbands. The base station measures the SRS to obtain channel state information, where the channel state information is obtained by measuring the CSI-RS sent in the at least one subband.

### CROSS-REFERENCE TO RELATED APPLICATIONS

This application is a continuation of International Application No. PCT/CN2017/093476, filed on Jul. 19, 2017, which claims priority to Chinese Patent Application No. 201610652011.7, filed on Aug. 10, 2016. The disclosures of the aforementioned applications are hereby incorporated by reference in their entireties.

### TECHNICAL FIELD

This application relates to the field of communications technologies, and in particular, to a reference signal measurement method and apparatus.

### BACKGROUND

A channel state information-reference signal (CSI-RS) and a sounding reference signal (SRS) are collectively referred to as reference signals. The reference signals are used to detect information about a channel, to determine communication quality of the channel. Existing LTE reference signals are basically scattered over an entire system bandwidth. Considering a forward compatibility requirement, a bandwidth of an NR (or can be called as 5G) reference signal (for example, the CSI-RS or the SRS) should be configurable. In a configuration solution, one subband is separately configured for each user. However, in this way, communication between a terminal device and a base station can be performed in only one subband.

A reference signal of a terminal device exists in only one subband. Therefore, the terminal device or the base station can obtain information about the terminal device in only one subband. When data transmission quality of the terminal device in one subband is poor, because the base station does not have information about the terminal device in another subband, the base station cannot blindly switch the terminal device to another subband, and a data transmission speed of the terminal device is affected.

Alternatively, when the base station desires to flexibly clear a subband, because the base station does not have information about the terminal device in another subband, the base station cannot determine a subband to which communication between the terminal device and the base station is to be switched, causing restrictions on some services of the base station.

### SUMMARY

Embodiments of the present invention provide a reference signal sending method and apparatus and a reference signal receiving method and apparatus. A plurality of subbands may be configured for one terminal device, to simultaneously obtain reference signals of the plurality of subbands, so that a base station can switch, based on a result of the reference signals, a subband used by the terminal device, thereby maintaining flexibility of a base station side and maximizing data transmission of the terminal device.

According to one aspect, a specific embodiment of the present invention provides a channel state information receiving method, including: sending, by a base station, first signaling to a terminal device. The first signaling includes channel state information-reference signal CSI-RS information of each of a plurality of subbands, and the CSI-RS information of each subband includes at least one of: a period of a CSI-RS in the subband, a starting position of the CSI-RS in the subband, an offset position of the CSI-RS in the subband, and a port number of the CSI-RS in the subband. The method further includes sending, by the base station, a CSI-RS in at least one of the plurality of subbands. The method further includes receiving, by the base station, channel state information sent by the terminal device. The channel state information is obtained by measuring the CSI-RS sent in the at least one subband. Therefore, the base station can receive channel state information of the plurality of subbands, thereby maintaining flexibility of a base station side and maximizing data transmission of the terminal device.

In a possible design, the first signaling is higher layer signaling, and after the sending, by a base station, first signaling to a terminal device, the method further includes: sending, by the base station, first physical layer signaling to the terminal device. The first physical layer signaling is used to instruct the terminal device to measure the CSI-RS sent in the at least one subband. The terminal device is controlled, by using more flexible physical layer signaling, to execute the first signaling, thereby reducing overheads on a terminal device side.

In a possible design, the first signaling is higher layer signaling, and after the sending, by a base station, first signaling to a terminal device, the method further includes: sending second physical layer signaling to the terminal device. The second physical layer signaling is used to instruct the terminal device to stop measuring the CSI-RS sent in the at least one subband. The terminal device is controlled, by using more flexible physical layer signaling, to execute the first signaling, thereby reducing overheads on a terminal device side.

In a possible design, the at least one subband is the same as the plurality of subbands; the first signaling is physical layer signaling, and the physical layer signaling further includes a valid time period. The valid time period is shared by the plurality of subbands, and the valid time period is used to indicate that the terminal device measures, within the valid time period, the CSI-RS sent in the plurality of subbands. In a possible design, there are a plurality of valid time periods, each subband corresponds to one of the plurality of valid time periods, and each valid time period is used to indicate that the terminal device measures, within the valid time period, the CSI-RS sent in a subband corresponding to the valid time period. The channel state information-reference signal CSI-RS information of each of the plurality of subbands is sent by using physical layer information, so that the channel state information-reference signal CSI-RS information of each subband is more flexibly sent.

According to another aspect, a specific embodiment of the present invention provides a channel state information sending method, including: receiving, by a terminal device, first signaling sent by a base station. The first signaling includes channel state information-reference signal CSI-RS information of each of a plurality of subbands, and the CSI-RS information of each subband includes at least one of: a period of a CSI-RS in the subband, a starting position of the CSI-RS in the subband, an offset position of the CSI-RS in the subband, and a port number of the CSI-RS in the subband. The method further includes receiving, by the terminal device, a CSI-RS in at least one of the plurality of subbands. The method further includes measuring, by the terminal device, the CSI-RS in the at least one subband, to obtain channel state information; and sending, by the terminal device, the channel state information to the base station. Therefore, the base station can receive channel state information of the plurality of subbands, thereby maintaining flexibility of a base station side and maximizing data transmission of the terminal device.

In a possible design, the first signaling is higher layer signaling. After the receiving, by a terminal device, first signaling sent by a base station, the method further includes: receiving, by the terminal device, first physical layer signaling sent by the base station. The first physical layer signaling is used to instruct the terminal device to measure the CSI-RS received in the at least one subband. The terminal device is controlled, by using more flexible physical layer signaling, to execute the first signaling, thereby reducing overheads on a terminal device side.

In a possible design, the first signaling is higher layer signaling. After the receiving, by a terminal device, first signaling sent by a base station, the method further includes: receiving, by the terminal device, second physical layer signaling sent by the base station. The second physical layer signaling is used to instruct the terminal device to stop measuring the CSI-RS received in the at least one subband. The terminal device is controlled, by using more flexible physical layer signaling, to execute the first signaling, thereby reducing overheads on a terminal device side.

In a possible design, the at least one subband is the same as the plurality of subbands; the first signaling is physical layer signaling, and the physical layer signaling further includes a valid time period; and the valid time period is shared by the plurality of subbands, and the valid time period is used to indicate that the terminal device measures, within the valid time period, the CSI-RS received in the plurality of subbands; or there are a plurality of valid time periods, each subband corresponds to one of the plurality of valid time periods, and each valid time period is used to indicate that the terminal device measures, within the valid time period, the CSI-RS sent in a subband corresponding to the valid time period. The channel state information-reference signal CSI-RS information of each of the plurality of subbands is sent by using physical layer information, so that the channel state information-reference signal CSI-RS information of each subband is more flexibly sent.

According to still another aspect, a specific embodiment of the present invention provides a channel state information sending method, including: sending, by a base station, second signaling to a terminal device. The second signaling includes sounding reference signal SRS information of each of a plurality of subbands, and the SRS information of each subband includes at least one of: a period of an SRS in the subband, a starting position of the SRS in the subband, an offset position of the SRS in the subband, and a port number of the SRS in the subband. The method further includes receiving, by the base station in at least one of the plurality of subbands, an SRS sent by the terminal device; and measuring, by the base station, the SRS of the at least one subband, to obtain channel state information. Therefore, the base station can receive channel state information of the plurality of subbands, thereby maintaining flexibility of a base station side and maximizing data transmission of the terminal device.

In a possible design, the second signaling is higher layer signaling, and after the sending, by a base station, second signaling to a terminal device, the method further includes: sending, by the base station, first physical layer signaling to the terminal device, where the first physical layer signaling is used to instruct the terminal device to send the SRS of the at least one subband to the base station. The terminal device is controlled, by using more flexible physical layer signaling, to execute the first signaling, thereby reducing overheads on a terminal device side.

In a possible design, the second signaling is higher layer signaling. After the sending, by a base station, second signaling to a terminal device, the method further includes: sending, by the base station, second physical layer signaling to the terminal device. The second physical layer signaling is used to instruct the terminal device to stop sending the SRS of the at least one subband to the base station. The terminal device is controlled, by using more flexible physical layer signaling, to execute the first signaling, thereby reducing overheads on a terminal device side.

In a possible design, the at least one subband is the same as the plurality of subbands; the first signaling is physical layer signaling, and the physical layer signaling further includes a valid time period; and the valid time period is shared by the plurality of subbands, and the valid time period is used to indicate that the terminal device sends the SRS of the at least one subband to the base station within the valid time period; or there are a plurality of valid time periods, each subband corresponds to one of the plurality of valid time periods, and each valid time period is used to indicate that the terminal device sends the SRS to the base station within the valid time period in a subband corresponding to the valid time period. The terminal device is controlled, by using more flexible physical layer signaling, to execute the first signaling, thereby reducing overheads on a terminal device side.

According to yet another aspect, a specific embodiment of the present invention provides a channel state information sending method, including: receiving, by a terminal device, second signaling sent by a base station, where the second signaling includes sounding reference signal SRS information of each of a plurality of subbands, and the SRS information of each subband includes at least one of: a period of an SRS in the subband, a starting position of the SRS in the subband, an offset position of the SRS in the subband, and a port number of the SRS in the subband; sending, by the terminal device, a sounding reference signal SRS of at least one subband to the base station; and sending, by the terminal device, the SRS in at least one of the plurality of subbands. Therefore, the base station can receive channel state information of the plurality of subbands, thereby maintaining flexibility of a base station side and maximizing data transmission of the terminal device.

In a possible design, the second signaling is higher layer signaling, and after the receiving, by a terminal device, second signaling sent by a base station, the method further includes: receiving, by the terminal device, first physical layer signaling sent by the base station, where the first physical layer signaling is used to instruct the terminal device to send the SRS of the at least one subband to the base station. The terminal device is controlled, by using more flexible physical layer signaling, to execute the first signaling, thereby reducing overheads on a terminal device side.

In a possible design, the second signaling is higher layer signaling, and after the receiving, by a terminal device, second signaling sent by a base station, the method further includes: receiving, by the terminal device, second physical layer signaling sent by the base station, where the second physical layer signaling is used to instruct the terminal device to stop sending the SRS of the at least one subband to the base station. The terminal device is controlled, by using more flexible physical layer signaling, to execute the first signaling, thereby reducing overheads on a terminal device side.

In a possible design, the at least one subband is the same as the plurality of subbands; the first signaling is physical layer signaling, and the physical layer signaling further includes a valid time period; and the valid time period is shared by the plurality of subbands, and the valid time period is used to indicate that the terminal device sends the SRS of the at least one subband to the base station within the valid time period; or there are a plurality of valid time periods, each subband corresponds to one of the plurality of valid time periods, and each valid time period is used to indicate that the terminal device sends the SRS to the base station within the valid time period in a subband corresponding to the valid time period. The terminal device is controlled, by using more flexible physical layer signaling, to execute the first signaling, thereby reducing overheads on a terminal device side.

According to a still yet another aspect, a specific embodiment of the present invention provides a channel state information receiving method, including: sending, by a base station, physical layer signaling to a terminal device. The physical layer signaling includes channel state information-reference signal CSI-RS information, and the CSI-RS information includes at least one of a valid time period, a period of a CSI-RS, a starting position of the CSI-RS, an offset position of the CSI-RS, and a port number of the CSI-RS. The method further includes sending, by the base station, the CSI-RS at least within the valid time period based on the period of the CSI-RS. The method further includes receiving, by the base station, channel state information sent by the terminal device. The channel state information is obtained by measuring the CSI-RS sent within the valid time period. Therefore, the base station can receive channel state information of a plurality of subbands, thereby maintaining flexibility of a base station side and maximizing data transmission of the terminal device.

In a possible design, the at least one subband is the same as the plurality of subbands; the first signaling is physical layer signaling, and the physical layer signaling further includes a valid time period. The valid time period is shared by the plurality of subbands, and the valid time period is used to indicate that the terminal device measures, within the valid time period, the CSI-RS sent in the plurality of subbands. Alternatively, there are a plurality of valid time periods, each subband corresponds to one of the plurality of valid time periods, and each valid time period is used to indicate that the terminal device measures, within the valid time period, the CSI-RS sent in a subband corresponding to the valid time period. The terminal device is controlled, by using more flexible physical layer signaling, to execute the first signaling, thereby reducing overheads on a terminal device side.

According to a further aspect, a specific embodiment of the present invention provides a base station, including: a sending unit, configured to send first signaling to a terminal device. The first signaling includes channel state information-reference signal CSI-RS information of each of a plurality of subbands, and the CSI-RS information of each subband includes at least one of: a period of a CSI-RS in the subband, a starting position of the CSI-RS in the subband, an offset position of the CSI-RS in the subband, and a port number of the CSI-RS in the subband. The sending unit is further configured to send a CSI-RS in at least one of the plurality of subbands. The base station further includes a receiving unit, configured to receive channel state information sent by the terminal device, where the channel state information is obtained by measuring the CSI-RS sent in the at least one subband. Therefore, the base station can receive channel state information of the plurality of subbands, thereby maintaining flexibility of a base station side and maximizing data transmission of the terminal device.

In a possible design, the first signaling is higher layer signaling; and the sending unit is further configured to send first physical layer signaling to the terminal device after sending the first signaling to the terminal device, where the first physical layer signaling is used to instruct the terminal device to measure the CSI-RS received in the at least one subband. The terminal device is controlled, by using more flexible physical layer signaling, to execute the first signaling, thereby reducing overheads on a terminal device side.

In a possible design, the first signaling is higher layer signaling; and the sending unit is further configured to send second physical layer signaling to the terminal device after sending the first signaling to the terminal device, where the second physical layer signaling is used to instruct the terminal device to stop measuring the CSI-RS received in the at least one subband. The terminal device is controlled, by using more flexible physical layer signaling, to execute the first signaling, thereby reducing overheads on a terminal device side.

In a possible design, the at least one subband is the same as the plurality of subbands; the first signaling is physical layer signaling, and the physical layer signaling further includes a valid time period; and the valid time period is shared by the plurality of subbands, and the valid time period is used to indicate that the terminal device measures, within the valid time period, the CSI-RS received in the plurality of subbands. Alternatively, there are a plurality of valid time periods, each subband corresponds to one of the plurality of valid time periods, and each valid time period is used to indicate that the terminal device measures, within the valid time period, the CSI-RS sent in a subband corresponding to the valid time period. The terminal device is controlled, by using more flexible physical layer signaling, to execute the first signaling, thereby reducing overheads on a terminal device side.

According to a still further aspect, a specific embodiment of the present invention provides a terminal device. The terminal device includes: a receiving unit, configured to receive first signaling sent by a base station. The first signaling includes channel state information-reference signal CSI-RS information of each of a plurality of subbands, and the CSI-RS information of each subband includes at least one of: a period of a CSI-RS in the subband, a starting position of the CSI-RS in the subband, an offset position of the CSI-RS in the subband, and a port number of the CSI-RS in the subband. The receiving unit is further configured to receive a CSI-RS in at least one of the plurality of subbands; a processing unit, configured to measure the CSI-RS in the at least one subband, to obtain channel state information. The terminal device further includes a sending unit, configured to send the channel state information obtained by the terminal device through measurement to the base station. Therefore, the base station can receive channel state information of the plurality of subbands, thereby maintaining flexibility of a base station side and maximizing data transmission of the terminal device.

In a possible design, the first signaling is higher layer signaling. The receiving unit is further configured to receive first physical layer signaling sent by the base station after receiving the first signaling sent by the base station. The first physical layer signaling is used to instruct the terminal device to measure the CSI-RS sent in the at least one subband. The terminal device is controlled, by using more flexible physical layer signaling, to execute the first signaling, thereby reducing overheads on a terminal device side.

In a possible design, the first signaling is higher layer signaling. The receiving unit is further configured to receive second physical layer signaling sent by the base station after receiving the first signaling sent by the base station. The second physical layer signaling is used to instruct the terminal device to stop measuring the CSI-RS sent in the at least one subband. The terminal device is controlled, by using more flexible physical layer signaling, to execute the first signaling, thereby reducing overheads on a terminal device side.

In a possible design, the at least one subband is the same as the plurality of subbands; the first signaling is physical layer signaling, and the physical layer signaling further includes a valid time period; and the valid time period is shared by the plurality of subbands, and the valid time period is used to indicate that the terminal device measures, within the valid time period, the CSI-RS sent in the plurality of subbands. Alternatively, there are a plurality of valid time periods, each subband corresponds to one of the plurality of valid time periods, and each valid time period is used to indicate that the terminal device measures, within the valid time period, the CSI-RS sent in a subband corresponding to the valid time period. The channel state information-reference signal CSI-RS information of each of the plurality of subbands is sent by using physical layer information, so that the channel state information-reference signal CSI-RS information of each subband is more flexibly sent.

According to a yet further aspect, a specific embodiment of the present invention provides a base station. The base station includes: a sending unit, configured to send second signaling to a terminal device, where the second signaling includes sounding reference signal SRS information of each of a plurality of subbands, and the SRS information of each subband includes at least one of: a period of an SRS in the subband, a starting position of the SRS in the subband, an offset position of the SRS in the subband, and a port number of the SRS in the subband; a receiving unit, configured to receive, in at least one of the plurality of subbands, an SRS sent by the terminal device; and a processing unit, configured to measure the received SRS of the at least one subband, to obtain channel state information. Therefore, the base station can receive channel state information of the plurality of subbands, thereby maintaining flexibility of a base station side and maximizing data transmission of the terminal device.

In a possible design, the second signaling is higher layer signaling; and the sending unit is further configured to send first physical layer signaling to the terminal device after sending the second signaling to the terminal device, where the first physical layer signaling is used to instruct the terminal device to send the SRS of the at least one subband to the base station. The terminal device is controlled, by using more flexible physical layer signaling, to execute the first signaling, thereby reducing overheads on a terminal device side.

In a possible design, the second signaling is higher layer signaling; and the sending unit is further configured to send second physical layer signaling to the terminal device after sending the first signaling to the terminal device, where the second physical layer signaling is used to instruct the terminal device to stop sending the SRS of the at least one subband to the base station. The terminal device is controlled, by using more flexible physical layer signaling, to execute the first signaling, thereby reducing overheads on a terminal device side.

In a possible design, the at least one subband is the same as the plurality of subbands; the first signaling is physical layer signaling, and the physical layer signaling further includes a valid time period; and the valid time period is shared by the plurality of subbands, and the valid time period is used to indicate that the terminal device sends the SRS of the at least one subband to the base station within the valid time period; or there are a plurality of valid time periods, each subband corresponds to one of the plurality of valid time periods, and each valid time period is used to indicate that the terminal device sends the SRS to the base station within the valid time period in a subband corresponding to the valid time period. The terminal device is controlled, by using more flexible physical layer signaling, to execute the first signaling, thereby reducing overheads on a terminal device side.

According to a still yet further aspect, a specific embodiment of the present invention provides a terminal device, including: a receiving unit, configured to receive second signaling sent by a base station. The second signaling includes sounding reference signal SRS information of each of a plurality of subbands, and the SRS information of each subband includes at least one of: a period of an SRS in the subband, a starting position of the SRS in the subband, an offset position of the SRS in the subband, and a port number of the SRS in the subband. The terminal device further includes a sending unit, configured to send a sounding reference signal SRS of at least one subband to the base station, where the sending unit is further configured to send the SRS in at least one of the plurality of subbands. Therefore, the base station can receive channel state information of the plurality of subbands, thereby maintaining flexibility of a base station side and maximizing data transmission of the terminal device.

In a possible design, the second signaling is higher layer signaling. The receiving unit is further configured to receive first physical layer signaling sent by the base station after receiving the second signaling sent by the base station. The first physical layer signaling is used to instruct the terminal device to send the SRS of the at least one subband to the base station. The terminal device is controlled, by using more flexible physical layer signaling, to execute the first signaling, thereby reducing overheads on a terminal device side.

In a possible design, the second signaling is higher layer signaling; and the receiving unit is further configured to receive second physical layer signaling sent by the base station after receiving the second signaling sent by the base station, where the second physical layer signaling is used to instruct the terminal device to stop sending the SRS of the at least one subband to the base station. The terminal device is controlled, by using more flexible physical layer signaling, to execute the first signaling, thereby reducing overheads on a terminal device side.

In a possible design, the at least one subband is the same as the plurality of subbands; the first signaling is physical layer signaling, and the physical layer signaling further includes a valid time period; and the valid time period is shared by the plurality of subbands, and the valid time period is used to indicate that the terminal device sends the SRS of the at least one subband to the base station within the valid time period. Alternatively, there are a plurality of valid time periods, each subband corresponds to one of the plurality of valid time periods, and each valid time period is used to indicate that the terminal device sends the SRS to the base station within the valid time period in a subband corresponding to the valid time period. The terminal device is controlled, by using more flexible physical layer signaling, to execute the first signaling, thereby reducing overheads on a terminal device side.

This application provides a reference signal measurement method and apparatus. A plurality of subbands are configured for one terminal device, to simultaneously obtain reference signals of the plurality of subbands, so that a base station can switch, based on a result of the reference signals, a subband used by the terminal device, thereby maintaining flexibility of a base station side and maximizing data transmission of the terminal device.

### BRIEF DESCRIPTION OF THE DRAWINGS

FIG. 1 is a schematic diagram of a communications system according to an embodiment of the present invention;

FIG. 2 is a flowchart of a CSI-RS measurement method according to a specific embodiment of the present invention;

FIG. 3 shows patterns of CSI-RSs with a normal cyclic prefix according to a specific embodiment of the present invention;

FIG. 4 shows patterns of CSI-RSs with an extended cyclic prefix according to a specific embodiment of the present invention;

FIG. 5 is a flowchart of an SRS measurement method according to a specific embodiment of the present invention;

FIG. 6 is a flowchart of another CSI-RS measurement method according to a specific embodiment of the present invention;

FIG. 7 is a schematic structural diagram of a base station according to a specific embodiment of the present invention;

FIG. 8 is a schematic structural diagram of a terminal device according to a specific embodiment of the present invention;

FIG. 9 is a schematic structural diagram of a base station according to a specific embodiment of the present invention;

FIG. 10 is a schematic structural diagram of a terminal device according to a specific embodiment of the present invention;

FIG. 11 is a possible schematic structural diagram of the base station in the foregoing embodiments; and

FIG. 12 is a simplified schematic diagram of a possible design structure of the terminal device in the foregoing embodiments.

### DETAILED DESCRIPTION OF ILLUSTRATIVE EMBODIMENTS

The technical solutions of this application are further described in the following in detail with reference to the accompanying drawings and embodiments.

FIG. 1 is a schematic diagram of a communications system according to an embodiment of the present invention. As shown in FIG. 1, an architecture of the system may specifically include an access network device 101 and a plurality of terminal devices 102 (UE). The access network device 101 may communicate with the plurality of terminal devices 102. The access network device 101 communicates with the plurality of terminal devices 102 through transmission by using a channel. The channel may be divided into a plurality of subbands. The access network device 101 communicates with any terminal device 102 in a subband.

A specific embodiment of the present invention provides a reference signal measurement method and apparatus. According to the method and the apparatus, a parameter of signaling that is sent by the access network device 101 to the terminal devices 102 and that is used for measurement of a channel state information-reference signal is enabled to include a plurality of subbands, so that channel state information-reference signals obtained by the terminal devices 102 and a sounding reference signal obtained by the access network device 101 include channel state information-reference signals and sounding reference signals of the plurality of subbands. The plurality of subbands include a channel used in current communication between the access network device 101 and the terminal device 102. The terminal devices 102 send the obtained channel state information-reference signals to the access network device 101. The access network device 101 determines, based on the obtained channel state information-reference signals and the obtained sounding reference signal, quality of the current channel used in communication between the access network device 101 and the terminal devices 102, so that when the quality of the channel used in the current communication between the access network device 101 and the terminal devices 102 is poor or when the access network device 101 needs to clear a subband, the channel used in the current communication between the access network device 101 and the terminal devices 102 is switched to another subband that is of the plurality of subbands and that has better channel quality. Therefore, flexibility of use of a time-frequency resource can be maximized, and flexibility of an access network device 101 side and a data throughput on a terminal device 102 side are improved.

The terminal devices 102 may include various handheld devices having a wireless communications function, in-vehicle devices, wearable devices, computing devices or other processing devices connected to a wireless modem, and various forms of terminal devices (UE), mobile stations (MS), terminals, terminal equipments, or the like. For ease of description, in this application, the devices mentioned above are collectively referred to as a first terminal device or UE.

The access network device 101 may be an apparatus that is deployed in a radio access network and that is configured to provide a wireless communications function for UE or a WD. The apparatus may include various forms of macro base stations, micro base stations, regeneration stations, access points, or the like. In systems using different radio access technologies, names of devices having a base station function may be different. For example, in an Long Term Evolution (LTE) network, a device having the base station function is referred to as an evolved NodeB (eNB or eNodeB), and in a third generation 3G network, a device having the base station function is referred to as a node B. For ease of description, in this application, the foregoing apparatuses providing the wireless communication function for the UE are collectively referred to as a base station or an eNB.

The technologies described in the present invention may be applied to a Long Term Evolution (LTE) system, or other wireless communications systems using various radio access technologies, for example, systems using access technologies such as Code Division Multiple Access, Frequency Division Multiple Access, Time Division Multiple Access, orthogonal frequency division multiple access, and single carrier frequency division multiple access. In addition, the technologies described in the present invention may be applied to a subsequent evolved system, such as a fifth-generation 5G system, using the LTE system. For clarity, the LTE system is used only as an example herein for description. In the LTE system, an evolved universal terrestrial radio access network (E-UTRAN) is used as a radio access network, and an evolved packet core (EPC) is used as a core network. The UE accesses an IMS network by using the E-UTRAN and the EPC.

In a specific embodiment of the present invention, a reference signal includes a channel state information-reference signal (CSI-RS) and a sounding reference signal (SRS). The CSI-RS is used for downlink channel measurement, and the SRS is used for uplink channel measurement. The base station evaluates, based on the obtained CSI-RS and the obtained SRS, a channel used in communication between the base station and the terminal device. When the base station determines, based on the obtained CSI-RS and the obtained SRS, that quality of the channel used in the current communication between the base station and the terminal device is poor or when the base station needs to clear a subband, the communication between the base station and the terminal device is switched to another channel.

The following describes in detail a method for measuring CSI-RSs of a plurality of subbands in a specific embodiment of the present invention.

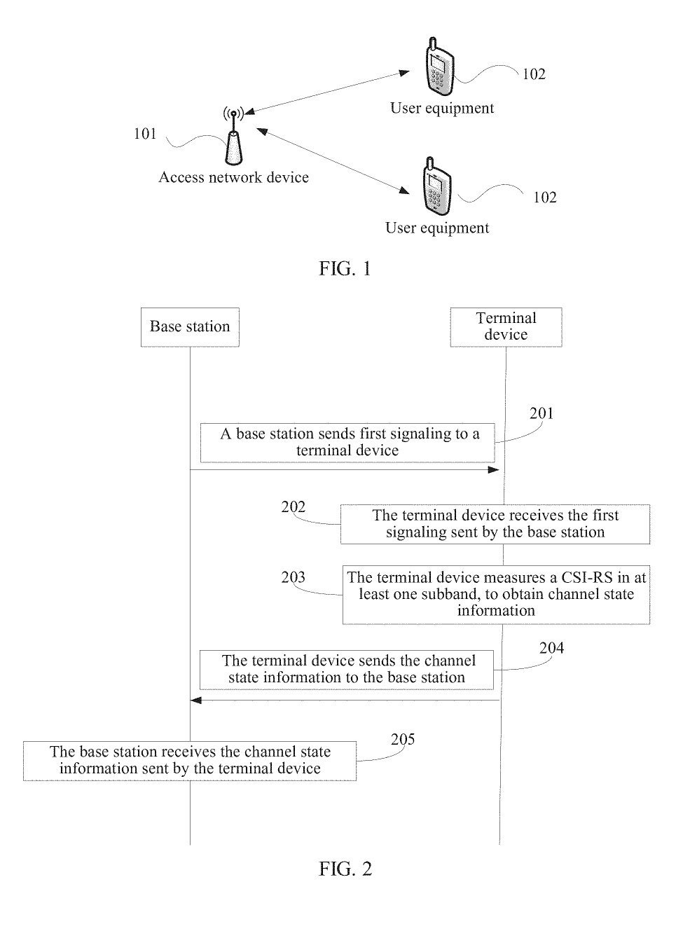

FIG. 2 is a flowchart of a CSI-RS measurement method according to a specific embodiment of the present invention. The method may be applied to the communications system shown in FIG. 1. As shown in FIG. 2, the method may include the following steps.

S201. A base station sends first signaling to a terminal device.

The first signaling includes a plurality of subbands and SRS information for each subband. The SRS information for each subband includes channel state information-reference signal CSI-RS information of each subband. The CSI-RS information of each subband includes at least one of: a period of a CSI-RS in the subband, a starting position of the CSI-RS in the subband, an offset position of the CSI-RS in the subband, and a port number of the CSI-RS in the subband.

Before the first signaling is sent to the terminal device, the method further includes: configuring the first signaling. The first signaling configured by the base station includes channel state information-reference signal CSI-RS information of each of a plurality of subbands, and the CSI-RS information of each subband includes at least one of: a period of a CSI-RS in the subband, a starting position of the CSI-RS in the subband, an offset position of the CSI-RS in the subband, and a port number of the CSI-RS in the subband.

In a specific embodiment of the present invention, that one piece of signaling includes a plurality of subbands may be that the signaling includes identification information of the plurality of subbands. After receiving signaling, the terminal device may determine, based on identification information of a subband included in the signaling, the subband for executing the signaling.

A channel of the base station is divided into a plurality of subchannels. In a message transmission process between the base station and the terminal device, communication between the base station and the terminal device is performed on a subchannel. Because a system bandwidth needs to be occupied during communication between the base station and the terminal device, a part of the system bandwidth and a data channel are allocated to each subchannel. A system bandwidth allocated to a subchannel is referred to as a subband.

In an example, a system bandwidth is 80 M, the system bandwidth is divided into a plurality of subbands, and each subband corresponds to one subchannel. For example, a channel is divided into a plurality of subchannels: A1, A2, A3 . . . , and the plurality of subbands obtained by dividing the system bandwidth are B1, B2, B3 . . . . The subchannel A1 corresponds to the subband B1, the subchannel A2 corresponds to the subband B2, and the subchannel A3 corresponds to the subband B3. Bandwidths allocated to the subbands may be distinguished by using physical resource blocks (PRBs). For example, a PRB 1 to a PRB 20 are the subband B1, a PRB 21 to a PRB 40 are the subband B2, a PRB 41 to a PRB 80 are the subband B3, and a PRB 81 to a PRB 100 are the subband B4. The rest can be deduced by analogy. The bandwidths of the subbands may be the same or different.

Alternatively, it may be understood that the system bandwidth is divided into a plurality of subbands, and each subband has a capability of transmitting data within a range corresponding to the subband.

In this embodiment of the present invention, the first signaling configured by the base station includes the plurality of subbands. to be specific, after receiving the first signaling, the terminal device can obtain, based on the information included in the first signaling, channel state information of the terminal device in the plurality of subbands. For example, the first signaling includes the subband B1 and the subband B2, so that the terminal device can obtain channel state information of the subband A1 and the subband A2 in the foregoing terminal device. If the subband A1 is a channel used in current communication between the terminal device and the base station, when an eNB intends to clear the subband A1 or when quality of data transmission of the terminal device in the subband A1 is poor, the channel between the base station and the terminal device may be switched to the subband A2.

The configuring the first signaling further includes configuring the channel state information-reference signal CSI-RS information for each subband. For example, the CSI-RS information that is of each subband and that is obtained through measurement by the terminal device includes at least one of: the period of the CSI-RS in the subband, the starting position of the CSI-RS in the subband, the offset position of the CSI-RS in the subband, and the port number of the CSI-RS in the subband.

In an example, to reduce consumption, separate parameters may be configured for different subbands. For example, the parameters corresponding to the subbands include different periods, different offset/starting positions, and different ports.

For example, subbands corresponding to B1 and B2 are configured. B1 is a main subband for data scheduling of the terminal device. The base station communicates with the terminal device by using a subband corresponding to the subband B1. Therefore, when a CSI-RS of the subband B1 is obtained, a short period can make a change in communication quality of the subband corresponding to the subband B1 to be obtained in time and then switching is performed. B2 is a candidate subband for data transmission of the terminal device. Therefore, when a CSI-RS of the subband B2 is obtained, the period is long.

The base station sends the configured first signaling to the terminal device. The base station sends the CSI-RS to user equipment in at least one of the plurality of subbands. For example, the first signaling includes the subband B1 and the subband B2. The subband B1 is a subband used in current communication between the base station and the terminal device. The subband B2 is a candidate subband. The base station sends the first signaling to the terminal device by using the subband B1. The terminal device obtains, based on the first signaling, channel state information of the plurality of subbands that are included in the first signaling.

The base station may send the first signaling to the terminal device by using higher layer signaling or by using physical layer signaling.

S202. The terminal device receives the first signaling sent by the base station.

The first signaling includes a related parameter corresponding to each of the plurality of subbands. The related parameter includes the channel state information-reference signal CSI-RS information of each of the plurality of subbands. The CSI-RS information of each subband includes at least one of: the period of the CSI-RS in the subband, the starting position of the CSI-RS in the subband, the offset position of the CSI-RS in the subband, and the port number of the CSI-RS in the subband. The first signaling is used to enable the terminal device to perform measurement to obtain the channel state information.

S203. The terminal device measures a CSI-RS in at least one subband, to obtain channel state information.

The terminal device measures, based on the CSI-RS information of each subband, the subbands included in the first signaling, to obtain the channel state information. The measuring, by the terminal device, the plurality of subbands included in the first signaling is measuring, based on the period of the CSI-RS of each subband, each of the plurality of subbands that are included in the first signaling, to obtain the channel state information of the terminal device in the plurality of subbands.

In a specific embodiment of the present invention, the terminal device performing measurement to obtain the channel state information for the plurality of subbands that are included in the first signaling may be performing measurement for each subband, or may be performing measurement for the plurality of subbands simultaneously. Specific measuring frequency is determined based on the period of the CSI-RS of each subband in the first signaling sent by the base station to the terminal device.

In a specific embodiment of the present invention, the terminal device receives the first signaling sent by the base station. The first signaling is used to enable the terminal device to perform measurement to obtain the channel state information. The first signaling includes the CSI-RS information of each subband. The channel state information of each subband included in the first signaling is obtained by using the CSI-RS information of each subband.

Different from the foregoing embodiment, in another specific embodiment of the present invention, the first signaling that is received by the terminal device and that is sent by the base station is sent by using higher layer signaling. After receiving the first signaling, the terminal device stores a plurality of subbands included in the higher layer signaling and SRS information of each of the plurality of subbands, where the SRS information of each subband includes a period of an SRS in the subband, a starting position of the SRS in the subband, an offset position of the SRS in the subband, and a port number of the SRS in the subband, but does not directly execute the first signaling.

The base station further sends first physical layer signaling to the terminal device. The first physical layer signaling may be sent at the time when the first signaling is being sent or may be sent at any time after the first signaling has been sent. This is not limited in the present invention.

After receiving a first physical layer signal used to instruct the terminal device to execute the first signaling, the terminal device executes the first signaling based on the first physical layer signaling, and performs measurement for at least one of the plurality of subbands, to obtain the channel state information of the at least one subband.

In an example, the physical layer signaling further includes a valid time period of the physical layer signaling. For example, if the valid time period of the physical layer signaling is one minute after the physical layer signaling is received, the terminal device starts to execute the higher layer signaling after receiving the physical layer signaling, and stops executing the higher layer signaling after executing the higher layer signaling for one minute. The terminal device executes higher layer signaling again based on newly received physical layer signaling after subsequently receiving the corresponding physical layer signaling.

Obviously, in the foregoing specific implementation, it is considered by default that the terminal device does not directly perform measurement to obtain the channel state information based on the higher layer signaling when receiving the higher layer signaling. In this way, sending density of measuring the channel state information by the terminal device can be maximally reduced, thereby effectively reducing overheads, and also reducing electricity consumption of the terminal device. The terminal device also does not perform measurement to obtain the channel state information by default. Therefore, the terminal device does not need to feed back a corresponding measurement result to the base station, thereby reducing overheads of an uplink control channel. Because the physical layer signaling is very dynamic, the base station can send the physical layer signaling to the terminal device in real time, so that the base station controls, in real time, the terminal device to execute or not execute higher layer signaling, thereby greatly reducing a possibility of always sending a signal, and maintaining forward compatibility.

In still another specific embodiment of the present invention, the first signaling that is received by the terminal device and that is sent by the base station is sent by using the higher layer signaling. After receiving the first signaling, the terminal device stores a plurality of subbands included in the first signaling and channel state information-reference signal CSI-RS information of each of the plurality of subbands, where the CSI-RS information of each subband includes at least one of: a period of a CSI-RS in the subband, a starting position of the CSI-RS in the subband, an offset position of the CSI-RS in the subband, and a port number of the CSI-RS in the subband. The base station is further configured to send to second physical layer signaling to the terminal device. After receiving the second physical layer signaling, the terminal device stops executing the first signaling.

In an example, the physical layer signaling further includes a valid time period of the physical layer signaling. For example, if the valid time period of the physical layer signaling is one hour after the physical layer signaling is received, the terminal device stops executing the first signaling after receiving the physical layer signaling, and continues to execute the first signaling after one hour. The terminal device determines, based on newly received physical layer signaling after subsequently receiving the corresponding physical layer signaling, a state of executing the first signaling.

In the foregoing specific embodiment of the present invention, after receiving the first signaling, the terminal device periodically performs measurement to the channel state information based on a configured parameter in the first signaling by default. In addition, an eNB may send physical layer signaling to the terminal device, and dynamically cancel, by using the physical layer signaling, measurement of the channel state information. Therefore, overheads of the terminal device can be effectively reduced, and electricity consumption of the terminal device can also be reduced. The terminal device may not perform measurement to obtain channel state information of one or more subbands according to an indication, and does not need to feed back a corresponding result, thereby reducing overheads of an uplink control channel. Because the physical layer signaling is very dynamic, the base station can dynamically send the physical layer signaling, thereby greatly reducing a possibility of always sending the higher layer signaling, and greatly maintaining forward compatibility.

In a specific embodiment of the present invention, the foregoing specific implementation may be executing first signaling after the first signaling is received, and stopping executing the first signaling after second physical layer signaling is received. Alternatively, the foregoing specific implementation may be not executing first signaling after the first signaling is received, starting to execute first physical layer signaling after the first physical layer signaling is received, and stopping executing the first signaling after second physical layer signaling is received. A combination of the foregoing two implementations or another specific implementation including the foregoing three specific implementations is not further specifically limited in the present invention.

In still another specific embodiment of the present invention, the first signaling that is received by the terminal device and that is sent by the base station is sent by using the physical layer signaling. After receiving the first signaling, the terminal device performs measurement to obtain the channel state information based on the CSI-RS information of each subband included in the first signaling. After the first signaling has been executed, when the channel state information needs to be obtained again, new first signaling needs to be received. Channel state information is obtained based on identifiers of subbands included in the new first signaling, a period of a CSI-RS in each subband, a starting/offset position and a port number for sending a measurement result to the base station, and the like, and the channel state information is sent to the base station.

In an example, the first signaling further includes a valid time period of the first signaling. The valid time period is a valid time period shared by the plurality of subbands, or there may be a plurality of valid time periods. If the valid time period is shared by the plurality of subbands, the valid time period is used to indicate that the terminal device measures, within the valid time period, the CSI-RS sent in the plurality of subbands. For example, if the valid time period of the first signaling is one minute after the first signaling is received, the terminal device starts to execute the first signaling after receiving the first signaling, and stops executing the first signaling after executing the first signaling for one minute.

If there are a plurality of valid time periods, each subband corresponds to one of the plurality of valid time periods, and each valid time period is used to indicate that the terminal device measures, within the valid time period, the CSI-RS sent in a subband corresponding to the valid time period.

After subsequently receiving corresponding first signaling, the terminal device executes the newly received first signaling.

S204. The terminal device sends the channel state information to the base station.

After obtaining the channel state information of the at least one subband, the terminal device may immediately send a channel measurement result to the base station, so that the base station adjusts, based on the obtained channel state information, a subband used in current communication between the terminal device and the base station. In an example, the terminal device may send channel state information of a subband to the base station in a fixed period. A measurement result is sent to the base station once in a period. The measurement result sent once includes the channel state information of the plurality of subbands for which measurement is performed in the period, thereby reducing overheads of an uplink control channel.

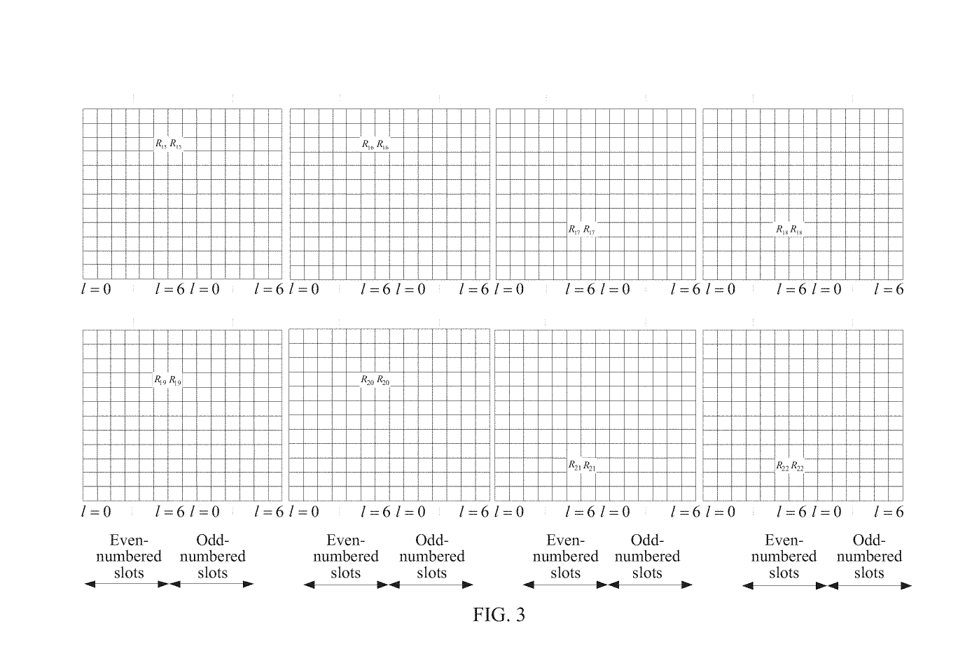

FIG. 3 shows patterns of CSI-RSs with a normal cyclic prefix according to a specific embodiment of the present invention. As shown in FIG. 3, a CSI-RS measurement result sent by the terminal device to the base station occupies only two resource elements (RE) in one PRB. R15 represents that an antenna port of sending the information is 15.

For example, R15 and R16 mean that when the CSI-RS measurement result is sent by using the antenna port 15 or an antenna port 16, two REs of a CSI-RS are in a third subcarrier of a symbol 6 and a symbol 7 in a first timeslot.

R17 and R18 mean that when the CSI-RS measurement result is sent by using an antenna port 17 or an antenna port 18, two REs of a CSI-RS are in a ninth subcarrier of a symbol 6 and a symbol 7 in a timeslot.

R19 and R20 mean that when the CSI-RS measurement result is sent by using an antenna port 19 or an antenna port 20, two REs of a CSI-RS are in a fourth subcarrier of a symbol 6 and a symbol 7 in a timeslot.

R21 and R22 mean that when the CSI-RS measurement result is sent by using an antenna port 21 or an antenna port 22, two REs of a CSI-RS are in a tenth subcarrier of a symbol 6 and a symbol 7 in a timeslot.

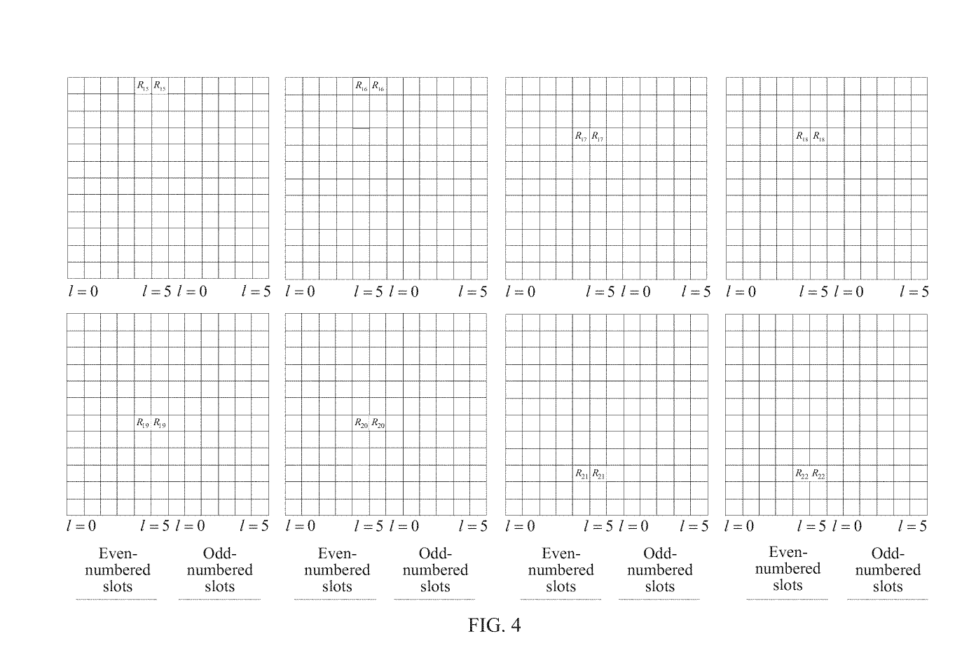

FIG. 4 shows patterns of CSI-RSs with an extended cyclic prefix according to a specific embodiment of the present invention. As shown in FIG. 4, a CSI-RS measurement result sent by the terminal device to the base station occupies only two resource elements (RE) in one PRB. R15 represents that an antenna port of sending the information is 15.

For example, R15 and R16 means that when the CSI-RS measurement result is sent by using the antenna port 15 or an antenna port 16, two REs of a CSI-RS are in a first subcarrier of a symbol 5 and a symbol 6 in a first timeslot.

R17 and R18 mean that when the CSI-RS measurement result is sent by using an antenna port 17 or an antenna port 18, two REs of a CSI-RS are in a fourth subcarrier of a symbol 5 and a symbol 6 in a timeslot.

R19 and R20 mean that when the CSI-RS measurement result is sent by using an antenna port 19 or an antenna port 20, two REs of a CSI-RS are in a seventh subcarrier of a symbol 5 and a symbol 6 in a timeslot.

R21 and R22 mean that when the CSI-RS measurement result is sent by using an antenna port 21 or an antenna port 22, two REs of a CSI-RS are in a tenth subcarrier of a symbol 5 and a symbol 6 in a timeslot.

S205. The base station receives the channel state information sent by the terminal device.

In an example, a result that is of a CSI-RS measured by a terminal device A and that is received by the base station includes measurement results of a subband 0110 and a subband 0111. The subband 0110 is a subband used in current communication between the base station and the terminal device A. The subband 0111 is a candidate communications channel between the base station and the terminal device A. If the base station determines, based on the result, that communication quality of the subband 0110 is poor and communication quality of the subband 0111 is relatively good, the base station changes the channel used in communication with the terminal device A from the subband 0110 into the subband 0111.

The following describes in detail a method for measuring SRSs of a plurality of subbands in a specific embodiment of the present invention.

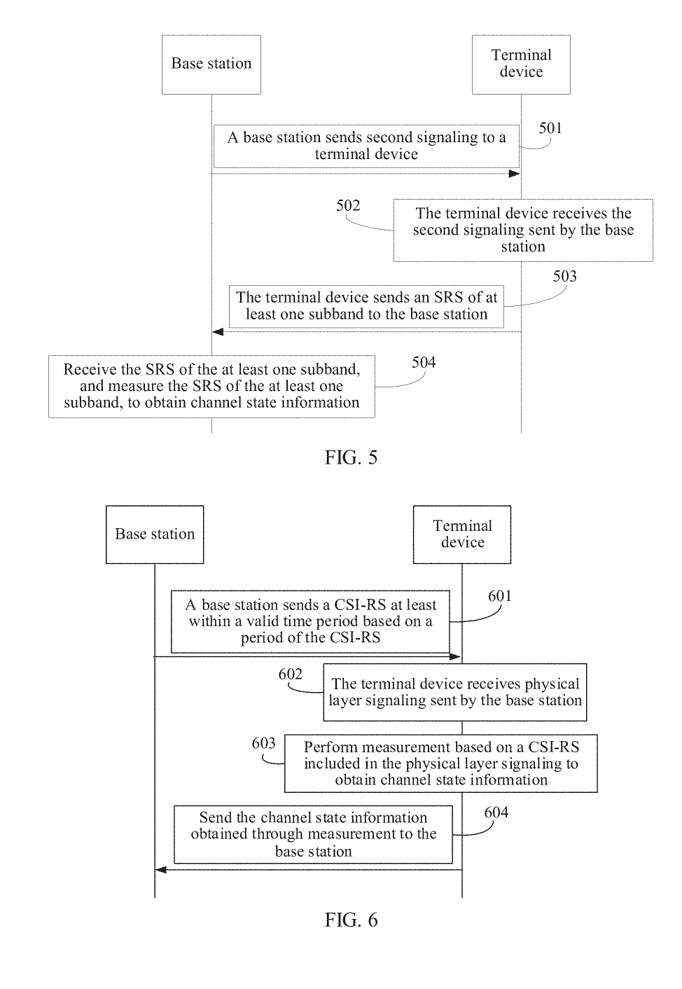

FIG. 5 is a flowchart of an SRS measurement method according to a specific embodiment of the present invention. The method may be applied to the communications system shown in FIG. 1. As shown in FIG. 5, the method may include the following steps.

S501. A base station sends second signaling to a terminal device.

The second signaling includes sounding reference signal (SRS) information of each of a plurality of subbands. The SRS information of each subband includes at least one of: a period of an SRS in the subband, a starting position of the SRS in the subband, an offset position of the SRS in the subband, and a port number of the SRS in the subband.

Before the second signaling is sent to the terminal device, the method further includes: configuring, by the base station, the second signaling. The second signaling configured by the base station includes the plurality of subbands and the SRS information of each subband. The SRS information of each subband includes at least one of: the period of the SRS in the subband, the starting position of the SRS in the subband, the offset position of the SRS in the subband, and the port number of the SRS in the subband.

In a specific embodiment of the present invention, that one piece of signaling includes a plurality of subbands may be that the signaling includes identification information of the plurality of subbands. After receiving signaling, the terminal device may determine, based on identification information of a subband included in the signaling, the subband for executing the signaling.

A channel of the base station is divided into a plurality of subchannels. Communication between the base station and the terminal device is performed on a subchannel. In a message transmission process between the base station and the terminal device, communication between the base station and the terminal device is performed on a subchannel. Because a system bandwidth and a data channel need to be occupied during communication between the base station and the terminal device, a part of the system bandwidth is further allocated to each subband. A bandwidth occupied on one subchannel is referred to as a subband.

In an example, a system bandwidth is 80 M, the system bandwidth is divided into a plurality of subbands, and each subband corresponds to one subchannel. For example, a channel is divided into a plurality of subchannels: A1, A2, A3 . . . , and the plurality of subbands obtained by dividing the system bandwidth are B1, B2, B3 . . . . The subchannel A1 corresponds to the subband B1, the subchannel A2 corresponds to the subband B2, and the subchannel A3 corresponds to the subband B3. Bandwidths allocated to the subbands may be distinguished by using physical resource blocks (PRBs). For example, a PRB 1 to a PRB 20 are the subband B1, a PRB 21 to a PRB 40 are the subband B2, a PRB 41 to a PRB 80 are the subband B3, and a PRB 81 to a PRB 100 are the subband B4. The rest can be deduced by analogy. The bandwidths of the subbands may be the same or different. The base station communicates with the terminal device by using a subband on a subchannel.

Alternatively, it may be understood that a channel is divided into a plurality of subbands, and each subband has a data transmission capability of a subband corresponding to each subchannel.

In a specific embodiment of the present invention, the plurality of subbands in the second signaling configured by the base station include at least two subbands, so that the base station can obtain sounding reference signals of the corresponding terminal device in the at least two subbands after executing the second signaling.

For example, the second signaling includes the subband B1 and the subband B2, so that the base station can obtain sounding reference signals of the subband B1 and the subband B2 on the foregoing channel. If the subband B1 is a channel used in current communication between the terminal device and the base station, when an eNB intends to clear the subband B1 or when quality of data transmission of the terminal device in the subband B1 is poor, the channel between the base station and the terminal device may be switched from the subband B1 to the subband B2.

The second signaling further includes information that is used for obtaining a sounding reference signal and that is configured for each of the plurality of subbands, for example, the period of the SRS in each subband, an offset/starting position and a port for sending a measurement result to the base station. In an example, to reduce consumption, separate parameters may be configured for subbands having different functions. For example, the SRS information of each subband includes at least one of: the period of the SRS in the subband, the starting position of the SRS in the subband, the offset position of the SRS in the subband, and the port number of the SRS in the subband.

For example, subbands corresponding to B1 and B2 are configured. B1 is a main subband for data scheduling of the terminal device. The base station communicates with the terminal device by using a subband corresponding to the subband B1. Therefore, when the base station obtains an SRS of the subband B1, a short period can make a change in communication quality of the subband corresponding to the subband B1 to be obtained in time and switching is performed. B2 is a candidate subband for data transmission of the terminal device. Therefore, when an SRS of the subband B2 is obtained, the period is long.

After completing configuring the second signaling, the base station further sends the configured second signaling to the terminal device, so that the terminal device obtains, based on the second signaling, the SRS information of the plurality of subbands that are included in the second signaling.

The second signaling may be sent by using higher layer signaling or by using physical layer signaling.

S502. The terminal device receives the second signaling sent by the base station.

The second signaling includes the plurality of subbands and the SRS information of each subband. The SRS information of each subband included in the SRS information includes at least one of: the period of the SRS in the subband, the starting position of the SRS in the subband, the offset position of the SRS in the subband, and the port number of the SRS in the subband.

S503. The terminal device sends a sounding reference signal to the base station based on the received second signaling.

In a specific embodiment of the present invention, after receiving the second signaling sent by the base station, the terminal device sends, in at least one of the plurality of subbands, an SRS of at least one subband to the base station based on the second signaling. Sending the SRS to the base station is sending an SRS of a subband to the base station based on SRS information of a subband in the second signaling. The base station performs measurement for a subband based on the SRS of the at least one subband sent by the terminal device, to obtain a sounding reference signal of the subband.

Different from the foregoing embodiment, in another specific embodiment of the present invention, the second signaling that is received by the terminal device and that is sent by the base station is sent by using higher layer signaling. After receiving the second signaling, the terminal device stores the sounding reference signal SRS information of each of the plurality of subbands that are included in the second signaling, where the SRS information of each subband includes at least one of: the period of the SRS in the subband, the starting position of the SRS in the subband, the offset position of the SRS in the subband, and the port number of the SRS in the subband, but does not directly send the SRS of the at least one subband to the base station.

The base station is further configured to send first physical layer signaling to user equipment. The terminal device receives the first physical layer signaling, and executes the second signaling based on the first physical layer signaling, to send the SRS of the at least one subband to the base station.

The base station may send the first physical layer signaling to the user equipment at the time when the second signaling is being sent, or may send the first physical layer signaling at any time after the second signaling has been sent.

The first physical layer signaling may directly instruct the terminal device to execute the first signaling, or may instruct the terminal device to execute the first signaling after any time period, and may further instruct the terminal device to execute the second signaling within a time period, or may instruct the terminal device to execute the second signaling in any other manner.

In an example, the first physical layer signaling further includes a valid time period of the first physical layer signaling. For example, if the valid time period of the first physical layer signaling is one minute after the first physical layer signaling is received, the terminal device starts to execute the second signaling after receiving the first physical layer signaling, and stops executing the second signaling after executing the second signaling for one minute. The terminal device executes the second signaling based on newly received first physical layer signaling after subsequently receiving the first physical layer signaling again, to send the SRS of the at least one subband to the base station.

Obviously, in the foregoing specific implementation, it is considered by default that the terminal device does not directly send the SRS of the at least one subband to the base station when receiving the second signaling. In this way, density of sending the SRS by the terminal device can be maximally reduced, thereby reducing overheads of an uplink control channel, and also reducing electricity consumption of the terminal device. The base station does not measure the sounding reference signal, thereby effectively reducing overheads. Because the physical layer signaling is very dynamic, the base station can send the physical layer signaling to the terminal device in real time, so that the base station controls, in real time, the terminal device to execute or not execute the second signaling, thereby greatly reducing a possibility of always sending a signal, and greatly maintaining forward compatibility.

In yet another specific embodiment of the present invention, the second signaling that is received by the terminal device and that is sent by the base station is sent by using the higher layer signaling. After receiving the second signaling, the terminal device stores the sounding reference signal SRS information of each of the plurality of subbands that are included in the second signaling, where the SRS information of each subband includes at least one of: the period of the SRS in the subband, the starting position of the SRS in the subband, the offset position of the SRS in the subband, and the port number of the SRS in the subband, and executes the second signaling, to send the SRS to the base station.

The base station further sends the second physical layer signaling to the terminal device. After receiving the second physical layer signaling, the terminal device stops, according to an indication of the second physical layer signaling, sending the SRS of the at least one subband to the base station.

In an example, the second physical layer signaling further includes a valid time period of the second physical layer signaling. For example, if the valid time period of the second physical layer signaling is one hour after the second physical layer signaling is received, the terminal device stops sending the SRS of the at least one subband to the base station after receiving the second physical layer signaling, and continues to send the SRS of the at least one subband to the base station after one hour. The terminal device determines, based on newly received second physical layer signaling after subsequently receiving the second physical layer signaling, a state of executing the second signaling.

In the foregoing specific embodiment of the present invention, after receiving the second signaling, the terminal device periodically sends the SRS of the at least one subband to the base station based on a configured parameter in the second signaling by default. In addition, an eNB may send physical layer signaling to the terminal device, and dynamically cancel, by using the physical layer signaling, sending of the SRS to the base station. Therefore, overheads of the terminal device can be effectively reduced, and electricity consumption of the terminal device can also be reduced. The terminal device may not send the SRS to the base station according to an indication, thereby also reducing overheads of an uplink control channel. Because the physical layer signaling is very dynamic, the base station dynamically sends the physical layer signaling, thereby greatly reducing a possibility of always sending the higher layer signaling, and greatly maintaining forward compatibility.

In a specific embodiment of the present invention, the foregoing specific implementation may be sending the SRS of the at least one subband to the base station after the second signaling is received, and stopping sending the SRS of the at least one subband to the base station after second physical layer signaling is received. Alternatively, the foregoing specific implementation may be not sending the SRS of the at least one subband to the base station after the second signaling is received, starting to send the SRS of the at least one subband to the base station after first physical layer signaling is received, and stopping sending the SRS of the at least one subband to the base station after second physical layer signaling is received. A combination of the foregoing two implementations or another specific implementation including the foregoing three specific implementations is not further specifically limited in the present invention.

In still another specific embodiment of the present invention, the signaling that is received by the terminal device and that is sent by the base station is sent by using the physical layer signaling. After receiving the physical layer signaling, the terminal device uses sounding reference signal SRS information of each of a plurality of subbands that are included in the physical layer signaling. The SRS information of each subband includes at least one of: a period of an SRS in the subband, a starting position of the SRS in the subband, an offset position of the SRS in the subband, and a port number of the SRS in the subband.

In an example, the second signaling further includes a valid time period of the second signaling. The valid time period is a valid time period shared by the plurality of subbands, or there may be a plurality of valid time periods. If the valid time period is shared by the plurality of subbands, the valid time period is used to indicate that the terminal device sends SRSs of the plurality of subbands to the base station within the valid time period. For example, if the valid time period of the second signaling is one minute after the second signaling is received, the terminal device starts to execute the second signaling after receiving the second signaling, and stops executing the second signaling after executing the second signaling for one minute.

If there are a plurality of valid time periods, each subband corresponds to one of the plurality of valid time periods, and each valid time period is used to indicate that the terminal device measures, within the valid time period, the CSI-RS sent in a subband corresponding to the valid time period.

After subsequently receiving corresponding first signaling, the terminal device executes the newly received first signaling.

S504. The base station measures the SRS of the at least one subband, to obtain channel state information.

The base station measures the received SRS. The SRS includes a subband for which the SRS needs to be measured. The base station measures the SRS to obtain uplink channel state information of a subband included in the SRS.

FIG. 6 shows another CSI-RS measurement method according to a specific embodiment of the present invention. As shown in FIG. 6, the method further specifically includes the following steps.

S601. A base station sends physical layer signaling to a terminal device, and the base station sends a CSI-RS at least within a valid time period based on a period of the CSI-RS.

The physical layer signaling includes channel state information-reference signal CSI-RS information. The CSI-RS information includes at least one of the valid time period, the period of the CSI-RS, a starting position of the CSI-RS, an offset position of the CSI-RS, and a port number of the CSI-RS.

The physical layer signaling includes the period of the CSI-RS. The period is used to indicate that the base station sends the CSI-RS to the terminal device based on the period of the CSI-RS, so that the terminal device receives the CSI-RS in each period, and measures the CSI-RS.

The physical layer signaling may include one subband, or may include a plurality of subbands. When the physical layer signaling includes a plurality of subbands, the physical layer signaling includes channel state information-reference signal information of each subband. Each subband may have a same CSI-RS or a different CSI-RS. When the physical layer signaling includes one subband, the base station needs to send physical layer signaling of a plurality of different subbands to a terminal device. The sent physical layer signaling of the plurality of different subbands is determined based on a period of each piece of physical layer signaling, so that the terminal device measures, within the valid time period based on the physical layer signaling, for at least one subband included in the physical layer signaling, to obtain channel state information of the at least one subband.

The measuring, by the terminal device, at least one subband included in the physical layer signaling is measuring, based on a period of the CSI-RS of each subband, each of the plurality of subbands that are included in the physical layer signaling, to obtain channel state information of the terminal device in the at least one subband.

Before the physical layer signaling is sent to the terminal device, the method further includes: configuring the physical layer signaling. The physical layer signaling configured by the base station includes channel state information-reference signal CSI-RS information of the at least one subband. The CSI-RS information includes a valid time period of the physical layer signaling and at least one of: the period of the CSI-RS, the starting position of the CSI-RS, the offset position of the CSI-RS, and the port number of the CSI-RS.

The valid time period is one of the plurality of valid time periods that correspond to each subband. Each valid time period is used to indicate that the terminal device measures, within the valid time period, the CSI-RS sent in a subband corresponding to the valid time period.

In a specific embodiment of the present invention, that one piece of signaling includes at least one subband may be that the signaling includes identification information of the at least one subband. After receiving signaling, the terminal device may determine, based on identification information of a subband included in the signaling, the subband for executing the signaling.

A channel of the base station is divided into a plurality of subchannels. In a message transmission process between the base station and the terminal device, communication between the base station and the terminal device is performed on a subchannel. Because a system bandwidth needs to be occupied during communication between the base station and the terminal device, a part of the system bandwidth and a data channel are allocated to each subchannel. A system bandwidth allocated to a subchannel is referred to as a subband.

In an example, a system bandwidth is 80 M, the system bandwidth is divided into a plurality of subbands, and each subband corresponds to one subchannel. For example, a channel is divided into a plurality of subchannels: A1, A2, A3 . . . , and the plurality of subbands obtained by dividing the system bandwidth are B1, B2, B3 . . . . The subchannel A1 corresponds to the subband B1, the subchannel A2 corresponds to the subband B2, and the subchannel A3 corresponds to the subband B3. Bandwidths allocated to the subbands may be distinguished by using physical resource blocks (PRBs). For example, a PRB 1 to a PRB 20 are the subband B1, a PRB 21 to a PRB 40 are the subband B2, a PRB 41 to a PRB 80 are the subband B3, and a PRB 81 to a PRB 100 are the subband B4. The rest can be deduced by analogy. The bandwidths of the subbands may be the same or different.

Alternatively, it may be understood that the system bandwidth is divided into a plurality of subbands, and each subband has a capability of transmitting data within a range corresponding to the subband.

In this embodiment of the present invention, the physical layer signaling configured by the base station includes the plurality of subbands. To be specific, after receiving the physical layer signaling, the terminal device can obtain, based on information included in the physical layer signaling, channel state information of the terminal device in the plurality of subbands. For example, the physical layer signaling includes the subband B1 and the subband B2, so that the terminal device can obtain channel state information of the subband B1 and the subband B2 in the foregoing terminal device. If the subband B1 is a channel used in current communication between the terminal device and the base station, when an eNB intends to clear the subband B1 or when quality of data transmission of the terminal device in the subband B1 is poor, the channel between the base station and the terminal device may be switched to the subband B2.

The configuring physical layer signaling further includes configuring the channel state information-reference signal CSI-RS information for each subband. For example, the CSI-RS information that is of each subband and that is measured by the terminal device includes at least one of: the period of the CSI-RS in the subband, the starting position of the CSI-RS in the subband, the offset position of the CSI-RS in the subband, and the port number of the CSI-RS in the subband.

In an example, to reduce consumption, separate parameters may be configured for different subbands. For example, the parameters corresponding to the subbands include different periods, different offset/starting positions, and different ports.

For example, subbands corresponding to B1 and B2 are configured. B1 is a main subband for data scheduling of the terminal device. The base station communicates with the terminal device by using a subband corresponding to the subband B1. Therefore, when a CSI-RS of the subband B1 is obtained, a short period can make a change in communication quality of the subband corresponding to the subband B1 to be obtained in time and switching is performed. B2 is a candidate subband for data transmission of the terminal device. Therefore, when a CSI-RS of the subband B2 is obtained, the period is long.

The base station sends the configured physical layer signaling to the terminal device. The base station sends the CSI-RS to user equipment in at least one of the plurality of subbands. For example, the first signaling includes the subband B1 and the subband B2. The subband B1 is a subband used in current communication between the base station and the terminal device. The subband B2 is a candidate subband. The base station sends the first signaling to the terminal device by using the subband B1. The terminal device obtains, based on the first signaling, channel state information of the plurality of subbands that are included in the first signaling.

S602. The terminal device receives the physical layer signaling sent by the base station.

After receiving the physical layer signaling, the terminal device obtains a CSI-RS included in the physical layer signaling.

S603. Perform measurement based on CSI-RS information included in the physical layer signaling to obtain channel state information.

In an example, the physical layer signaling is used to instruct to measure a CSI-RS for a subband, and the terminal device performs measurement based on the physical layer signaling, to obtain channel state information of the terminal device in the subband. The physical layer signaling usually includes a CSI-RS of only one subband. Therefore, when the base station needs to obtain a CSI-RS of the terminal device in a plurality of subbands, the base station needs to send physical layer signaling of a plurality of different subbands to the terminal device. The terminal device receives the physical layer signaling of the plurality of different subbands that is sent by the base station, and performs measurement for a plurality of times based on the physical layer signaling of the plurality of different subbands, to obtain channel state information of the terminal device in the plurality of different subbands.

The terminal device sends the channel state information obtained through measurement to the base station.

S604. Send the channel state information obtained through measurement to the base station.

The base station receives the channel state information sent by the terminal device, where the channel state information is obtained by measuring the CSI-RS sent within the valid time period.

In an example, a result that is of the CSI-RS measured by the terminal device and that is received by the base station includes measurement results of a subband 0110 and a subband 0111. The subband 0110 is a subband used in current communication between the base station and the terminal device. The subband 0111 is a candidate communications channel between the base station and the terminal device. If the base station determines, based on the result, that communication quality of the subband 0110 is poor and communication quality of the subband 0111 is relatively good, the base station changes the channel used in communication with the terminal device from the subband 0110 into the subband 0111.

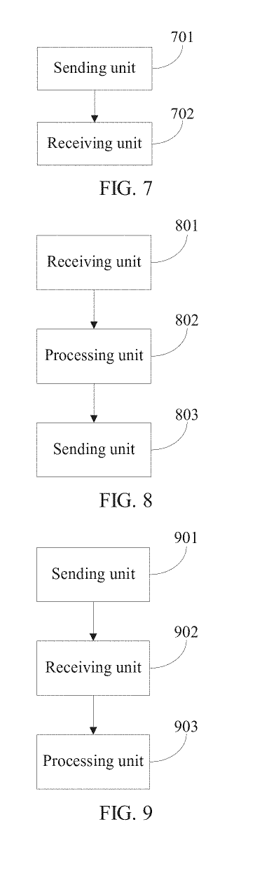

FIG. 7 is a schematic structural diagram of a base station according to a specific embodiment of the present invention. Referring to FIG. 7, the base station includes a sending unit 701. The sending unit 701 is configured to send first signaling to a terminal device. The first signaling includes channel state information-reference signal CSI-RS information of each of a plurality of subbands, and the CSI-RS information of each subband includes at least one of: a period of a CSI-RS in the subband, a starting position of the CSI-RS in the subband, an offset position of the CSI-RS in the subband, and a port number of the CSI-RS in the subband. The sending unit is further configured to send a CSI-RS in at least one of the plurality of subbands. The base station further includes a receiving unit 602, configured to receive channel state information sent by the terminal device, where the channel state information is obtained by measuring the CSI-RS sent in the at least one subband.

When the first signaling is higher layer signaling, the sending unit 701 is further configured to send first physical layer signaling to the terminal device. The terminal device measures, based on the first physical layer signaling, the CSI-RS sent in the at least one subband.

When the first signaling is higher layer signaling, the sending unit 701 is further configured to send second physical layer signaling to the terminal device. The terminal device stops, based on the second physical layer signaling, measuring the CSI-RS sent in the at least one subband.

When the first signaling is physical layer signaling, the physical layer signaling further includes a valid time period of the first signaling, so that the terminal device obtains, within the valid time period, channel state information of the plurality of subbands that are included in the first signaling.

FIG. 8 is a schematic structural diagram of a terminal device according to a specific embodiment of the present invention. As shown in FIG. 8, the terminal device includes a receiving unit 801, configured to receive first signaling sent by a sending unit 701 of a base station. The first signaling includes channel state information-reference signal CSI-RS information of each of a plurality of subbands, and the CSI-RS information of each subband includes at least one of: a period of a CSI-RS in the subband, a starting position of the CSI-RS in the subband, an offset position of the CSI-RS in the subband, and a port number of the CSI-RS in the subband. The receiving unit is further configured to receive a CSI-RS in at least one of the plurality of subbands. The terminal device further includes a processing unit 802, configured to measure the CSI-RS in the at least one subband, to obtain channel state information; and a sending unit 803, configured to send the channel state information obtained through measurement by the terminal device to the base station.

When the first signaling is higher layer signaling, the receiving unit 801 is further configured to receive first physical layer signaling sent by the sending unit 701 of the base station. The first physical layer signaling is used to instruct the terminal device to measure the CSI-RS sent in the at least one subband.

When the first signaling is higher layer signaling, the receiving unit 801 is further configured to receive second physical layer signaling sent by the sending unit 701 of the base station. The second physical layer signaling is used to instruct the terminal device to stop measuring the CSI-RS sent in the at least one subband.

The first signaling is physical layer signaling, and the physical layer signaling further includes a valid time period of the first signaling. The processing unit 802 obtains, within the valid time period, channel state information of the plurality of subbands that are included in the first signaling.

FIG. 9 is a schematic structural diagram of a base station according to a specific embodiment of the present invention. As shown in FIG. 9, the base station includes: a sending unit 901, configured to send second signaling to a terminal device. The second signaling includes sounding reference signal SRS information of each of a plurality of subbands, the SRS information of each subband includes at least one of: a period of an SRS in the subband, a starting position of the SRS in the subband, an offset position of the SRS in the subband, and a port number of the SRS in the subband, and the base station sends the SRS in at least one of the plurality of subbands. The base station further includes a receiving unit 902, configured to receive, in the at least one of the plurality of subbands, an SRS sent by the terminal device. The base station further includes a processing unit 903, configured to measure the received SRS of the at least one subband, to obtain channel state information.

When the second signaling is higher layer signaling, the sending unit 901 is further configured to send first physical layer signaling to the terminal device. The first physical layer signaling is used to instruct the terminal device to send the SRS of the at least one subband to the base station.

When the second signaling is higher layer signaling, the sending unit 901 is further configured to send second physical layer signaling to the terminal device. The second physical layer signaling is used to instruct the terminal device to stop sending the SRS of the at least one subband to the base station.

The first physical layer signaling further includes information used to indicate a valid time period of the first physical layer signaling.

When the second signaling is physical layer signaling, the terminal device sends a sounding reference signal to the base station based on the physical layer signaling. The sounding reference signal includes a subband in which uplink channel state information needs to be obtained.

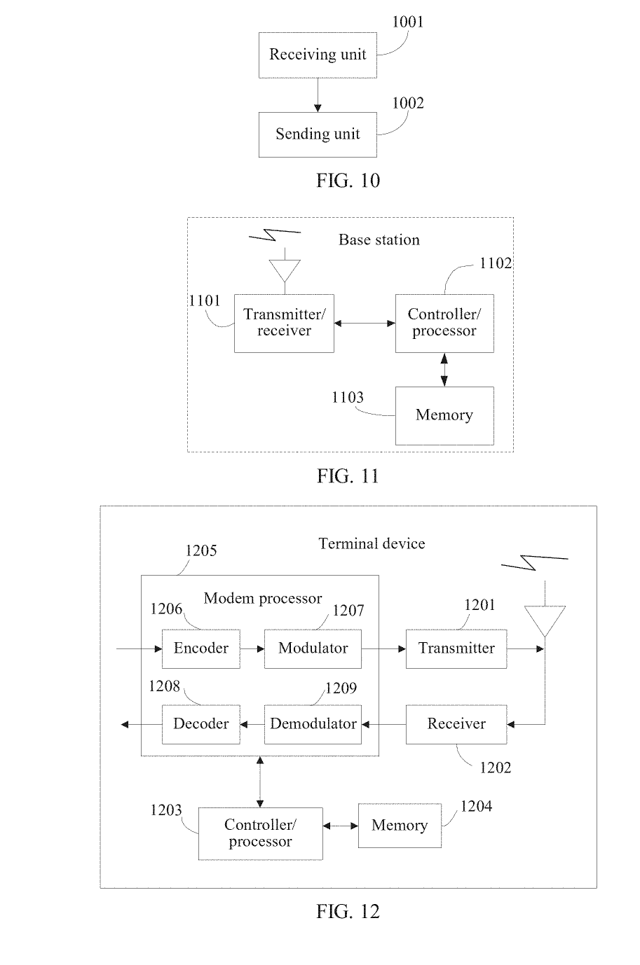

FIG. 10 is a schematic structural diagram of a terminal device according to a specific embodiment of the present invention. As shown in FIG. 10, the terminal device includes a receiving unit 1001, configured to receive second signaling sent by a sending unit 901 of the base station, where the second signaling includes a subband in which uplink channel state information needs to be obtained and SRS information of each subband. The SRS information of each subband includes at least one of: a period of an SRS in the subband, a starting position of the SRS in the subband, an offset position of the SRS in the subband, and a port number of the SRS in the subband. The terminal device further includes a sending unit 1002, configured to send an SRS of at least one subband to the base station.

When the second signaling received by the receiving unit 1001 is higher layer signaling, the receiving unit 1001 is further configured to receive first physical layer signaling sent by the sending unit 901 of the base station. The first physical layer signaling is used to instruct the terminal device to send the SRS of the at least one subband to the base station.

When the second signaling received by the receiving unit 1001 is higher layer signaling, the receiving unit 1001 is further configured to receive second physical layer signaling sent by the sending unit 901 of the base station. The second physical layer signaling is used to instruct the terminal device to stop sending the SRS of the at least one subband to the base station.

The physical layer signaling further includes information used to indicate a valid time period of the physical layer signaling.

When the second signaling received by the receiving unit 1001 is physical layer signaling, the physical layer signaling further includes information about a valid time period of the physical layer signaling, so that the sending unit 1002 sends the sounding reference signal to the terminal device within the valid time period of the physical layer signaling.

FIG. 11 is a possible schematic structural diagram of the base station in the foregoing embodiments.

The base station includes a transmitter/receiver 1101, a controller/processor 1102, and a memory 1103. The transmitter/receiver 1101 is configured to support information receiving and sending between the base station and the terminal device in the foregoing embodiment. The transmitter/receiver 1101 may be the sending unit 701 shown in FIG. 7 and the sending unit 803 shown in FIG. 8. The transmitter/receiver 1101 may be the receiving unit 702 shown in FIG. 7 and the receiving unit 801 shown in FIG. 8. The processor/controller may be the processing unit 802 shown in FIG. 8.

The controller/processor 1102 performs various functions used to communicate with the terminal device. On an uplink, an uplink signal from the terminal device is received by an antenna, is tuned by the receiver 1101, and is further processed by the controller/processor 1102 to recover service data and signaling information that are sent by the terminal device. On a downlink, service data and a signaling message are processed by the controller/processor 1102, and are tuned by the transmitter 1101, to generate a downlink signal, and the downlink signal is transmitted to the terminal device by using an antenna. The memory 1103 is configured to store program code and data of the base station.

It may be understood that FIG. 11 shows merely a simplified design of the base station. In an actual application, the base station may include any quantity of transmitters, receivers, processors, controllers, memories, communications units, and the like, and all base stations that can implement the present invention shall fall within the protection scope of the present invention.

FIG. 12 is a simplified schematic diagram of a possible design structure of the terminal device in the foregoing embodiment. The terminal device includes a transmitter 1201, a receiver 1202, a controller/processor 1203, a memory 1204, and a modem processor 1205. The transmitter 1201 may be the sending unit 901 shown in FIG. 9 and the sending unit 1002 shown in FIG. 10. The receiver 1202 may be the receiving unit 902 shown in FIG. 9 and the receiving unit 1001 shown in FIG. 10. The processor/controller 1203 may be the processing unit 903 shown in FIG. 9.

The transmitter 1201 adjusts (for example, analog-converts, filters, amplifies, and up-converts) output sampling and generates an uplink signal. The uplink signal is transmitted to the base station in the foregoing embodiment by using an antenna. On a downlink, the antenna receives a downlink signal transmitted by the base station in the foregoing embodiment. The receiver 1202 adjusts (for example, filters, amplifies, down-converts, and digitizes) a signal received from the antenna and provides input sampling. In the modem processor 1205, an encoder 1206 receives service data and a signaling message that are to be sent on an uplink, and processes (for example, performs formatting, encoding, and interleaving on) the service data and the signaling message. A modulator 1207 further processes (for example, performs symbol mapping and modulation on) the encoded service data and signaling message and provides output sampling. A demodulator 1209 processes (for example, demodulates) the input sampling and provides symbol estimation. A decoder 1208 processes (for example, performs de-interleaving and decoding on) the symbol estimation and provides decoded data and a decoded signaling message that are to be sent to UE. The encoder 1206, the modulator 1207, the demodulator 1209, and the decoder 1208 may be implemented by the combined modem processor 1205. These units perform processing based on a radio access technology (for example, access technologies in an LTE system and other evolved systems) used in a radio access network.

The processor/controller 1203 controls and manages an action of the terminal device, and is configured to perform processing performed by the terminal device in the foregoing embodiment, for example, is configured to control the terminal device to perform measurement to obtain the channel state information and/or other processes of the technologies described in the present invention. The memory 1204 is configured to store program code and data used for the UE.

A person skilled in the art may be further aware that, in combination with the examples described in the embodiments disclosed in this specification, units and algorithm steps can be implemented by electronic hardware, computer software, or a combination thereof. To clearly describe interchangeability between the hardware and the software, the foregoing has generally described compositions and steps of each example based on functions. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

A person of ordinary skill in the art may understand that all or some of the steps in each of the foregoing methods of the embodiments may be implemented by a program instructing a processor. The foregoing program may be stored in a computer readable storage medium. The storage medium is a non-transitory medium, such as a random-access memory, a read-only memory, a flash memory, a hard disk, a solid-state drive, a magnetic tape, a floppy disk, an optical disc, or any combination thereof.

The foregoing descriptions are merely examples of specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1.-16. (canceled)

17. A method, comprising:
sending, by a base station, second signaling to a terminal device, wherein the second signaling comprises respective sounding reference signal (SRS) information of each subband of a plurality of subbands, and the respective SRS information of each subband of the plurality of subbands comprises: a period of a respective SRS in a respective subband of the plurality of subbands, a starting position of the respective SRS in the respective subband of the plurality of subbands, an offset position of the respective SRS in the respective subband of the plurality of subbands, or a port number of the respective SRS in the respective subband of the plurality of subbands;
receiving, by the base station, in a first subband of the plurality of subbands, a first SRS of the first subband from the terminal device; and
measuring, by the base station, the first SRS of the first subband, to obtain channel state information.

18. The method according to claim 17, wherein the second signaling is higher layer signaling, and after sending the second signaling, the method further comprises:
sending, by the base station, first physical layer signaling to the terminal device, wherein the first physical layer signaling instructs the terminal device to send the first SRS of the first subband.

19. The method according to claim 17, wherein the second signaling is higher layer signaling, and after sending the second signaling, the method further comprises:
sending, by the base station, second physical layer signaling to the terminal device, wherein the second physical layer signaling instructs the terminal to stop sending the first SRS of the first subband.

20. The method according to claim 17, wherein receiving the first SRS of the first subband is part of receiving, by the base station in each subband of the plurality of subbands, a respective SRS of each subband of the plurality of subbands from the terminal device, the second signaling is physical layer signaling, and the physical layer signaling further comprises:
a valid time period is shared by each subband of the plurality of subbands, the valid time period indicates the terminal to send the respective SRS of each subband of the plurality of subbands within the valid time period; or
a plurality of valid time periods, each subband of the plurality of subbands corresponds to a respective one of the plurality of valid time periods, and each valid time period of the plurality of valid time periods indicates the terminal to send a respective SRS within a respective valid time period in a respective subband corresponding to the respective valid time period.

21. A method, comprising:
receiving, by a terminal device, second signaling from a base station, wherein the second signaling comprises respective sounding reference signal (SRS) information of each subband of a plurality of subbands, and the respective SRS information of each subband comprises a period of a respective SRS in a respective subband of the plurality of subbands, a starting position of the respective SRS in the respective subband of the plurality of subbands, an offset position of the respective SRS in the respective subband of the plurality of subbands, or a port number of the respective SRS in the respective subband of the plurality of subbands; and
sending, by the terminal device, a first SRS of a first subband of the plurality of subbands in the first subband.

22. The method according to claim 21, wherein the second signaling is higher layer signaling, and after receiving the second signaling, the method further comprises:
receiving, by the terminal device, first physical layer signaling from the base station, wherein the first physical layer signaling instructs the terminal to send the first SRS of the first subband.

23. The method according to claim 21, wherein the second signaling is higher layer signaling, and after receiving the second signaling, the method further comprises:
receiving, by the terminal device, second physical layer signaling from the base station, wherein the second physical layer signaling instructs the terminal to stop sending the first SRS of the first subband.

24. The method according to claim 21, wherein sending the first SRS of the first subband is part of sending, by the terminal device in each subband of the plurality of subbands, a respective SRS of each subband of the plurality of subbands, the second signaling is physical layer signaling, and the physical layer signaling further comprises:
a valid time period shared by each subband of the plurality of subbands, the valid time period indicate to the terminal to send the respective SRS of each subband of the plurality of subbands within the valid time period; or
a plurality of valid time periods, each subband of the plurality of subbands corresponds to a respective one of the plurality of valid time periods, and each valid time period of the plurality of valid time periods indicates the terminal to send a respective SRS within a respective valid time period in a respective subband corresponding to the respective valid time period.

25. An apparatus, comprises:
a non-transitory storage medium including executable instructions; and
a processor;
wherein the executable instructions, when executed by the processor, cause the apparatus to:
send second signaling to a terminal device, wherein the second signaling comprises respective sounding reference signal (SRS) information of each subband of a plurality of subbands, and the respective SRS information of each subband of the plurality of subbands comprises: a period of a respective SRS in a respective subband of the plurality of subbands, a starting position of the respective SRS in the respective subband of the plurality of subbands, an offset position of the respective SRS in the respective subband of the plurality of subbands, or a port number of the respective SRS in the respective subband of the plurality of subbands;
receive, in a first subband of the plurality of subbands, a first SRS from the terminal device; and
measure the first SRS of the first subband, to obtain channel state information.

26. The apparatus according to claim 25, wherein the second signaling is higher layer signaling; and
wherein the executable instructions, when executed by the processor, further cause the apparatus to:
send first physical layer signaling to the terminal device after sending the second signaling to the terminal device, wherein the first physical layer signaling instructs the terminal to send the first SRS of the first subband.

27. The apparatus according to claim 25, wherein the second signaling is higher layer signaling; and
wherein the executable instructions, when executed by the processor, further cause the apparatus to:
send second physical layer signaling to the terminal device after sending the second signaling to the terminal device, wherein the second physical layer signaling instructs to stop sending the first SRS of the first subband.

28. The apparatus according to claim 25, wherein the apparatus receives the first SRS of the first subband as part of instructions, when executed by the processor, cause the apparatus to receive, in each subband of the plurality of subbands, a respective SRS of each subband of the plurality of subbands from the terminal device, the second signaling is physical layer signaling, and the physical layer signaling further comprises:
a valid time period shared by each subband of the plurality of subbands, the valid time period indicates the terminal to send the respective SRS of each subband of the plurality of subbands within the valid time period; or
a plurality of valid time periods, each subband of the plurality of subbands corresponds to a respective one of the plurality of valid time periods, and each valid time period of the plurality of valid time periods indicates the terminal to send a respective SRS within a respective valid time period in a respective subband corresponding to the respective valid time period.

29. An apparatus, comprises:
a non-transitory storage medium including executable instructions; and
a processor;
wherein the executable instructions, when executed by the processor, cause the apparatus to:
receive second signaling from a base station, wherein the second signaling comprises respective sounding reference signal (SRS) information of each subband of a plurality of subbands, and the respective SRS information of each subband of the plurality of subbands comprises: a period of a respective SRS in a respective subband of the plurality of subbands, a starting position of the respective SRS in the respective subband of the plurality of subbands, an offset position of the respective SRS in the respective subband of the plurality of subbands, and a port number of the respective SRS in the respective subband of the plurality of subbands; and
send a first SRS of a first subband of the plurality of subbands in the first subband.

30. The apparatus according to claim 29, wherein the second signaling is higher layer signaling; and
wherein the executable instructions, when executed by the processor, cause the apparatus to:
receive first physical layer signaling from the base station after receiving the second signaling from the base station, wherein the first physical layer signaling instructs the apparatus to send the first SRS of the first subband to the base station.

31. The apparatus according to claim 30, wherein the second signaling is higher layer signaling; and
wherein the executable instructions, when executed by the processor, cause the apparatus to:
receive second physical layer signaling from the base station after receiving the second signaling from the base station, wherein the second physical layer signaling instructs the apparatus to stop sending the first SRS of the first subband.

32. The apparatus according to claim 30, wherein the apparatus sends the first SRS of the first subband as part of instructions, when executed by the processor, cause the apparatus to send, in each subband of the plurality of subbands, a respective SRS of each subband of the plurality of subbands to the base station, the second signaling is physical layer signaling, and the physical layer signaling further comprises:
a valid time period shared by the plurality of subbands, and the valid time period indicates the apparatus to send the respective SRS of each subband of the plurality of subbands within the valid time period; or
a plurality of valid time periods, each subband of the plurality of subbands corresponds to a respective one of the plurality of valid time periods, and each valid time period of the plurality of valid time periods indicates the apparatus to send a respective SRS within a respective valid time period in a respective subband corresponding to the respective valid time period.
